(19) United States
(12) Patent Application Publication
(10) Pub. No.: US 2014/0091750 A1
(43) Pub. Date: Apr. 3, 2014

(54) POWER SUPPLY APPARATUS AND CHARGING APPARATUS FOR ELECTRIC VEHICLE

(71) Applicant: PANASONIC CORPORATION, Osaka (JP)

(72) Inventor: Satoshi Ikeda, Osaka (JP)

(21) Appl. No.: 14/119,650

(22) PCT Filed: Apr. 2, 2012
(86) PCT No.: PCT/JP2012/002259

§ 371 Date: Nov. 22, 2013

(30) Foreign Application Priority Data
May 27, 2011 (JP) 2011-119461

(51) Int. Cl. B60L 11/18

(52) U.S. Cl. CPC B60L 11/1801
USPC 320/104

(57) ABSTRACT

A power supply apparatus for an electric vehicle includes a main battery, a sub-battery of lower voltage, a first output circuit unit including a first output sub-unit and a second output sub-unit, a control circuit unit, and a second output circuit unit including a third output sub-unit. The first output sub-unit receives electrical power from an external power supply and outputs first electrical power for main battery charging. The second output sub-unit receives electrical power from the power supply and outputs second electrical power for sub-battery charging. The control circuit unit individually controls charging of the main battery and the sub-battery by the first electrical power and the second electrical power respectively. The third output sub-unit receives electrical power from the power supply, via a different pathway compared to the first and second output sub-units, and outputs third electrical power for driving the control circuit unit.

### TECHNICAL FIELD

The present invention relates to a power supply apparatus and a charging apparatus for an electric vehicle including a main battery and a sub-battery which are chargeable. In particular, the present invention relates to an art of improving charging efficiency with regards to the sub-battery.

### BACKGROUND ART

Electric vehicles (EV) and hybrid electric vehicles (HEV) (referred to below collectively as electric vehicles), which use an electric motor as a source of drive, are attracting attention from a point of view of environmental protection and energy efficiency. An electric vehicle such as described above is provided with a power supply apparatus, including a chargeable battery (electricity accumulator), in order to perform functions such as supplying electrical power to the electric motor and accumulating electrical energy generated during regenerative braking through conversion of kinetic energy.

In a charging system for the battery in the electric vehicle, the battery may for example be charged through an external power supply, such as a commercial power supply or an EV charging station. A type of hybrid electric vehicle which can be charged through an external power supply may be more specifically referred to as a plug-in hybrid electric vehicle (PHEV). Electric vehicles such as described above are attracting attention due to improvement in overall fuel consumption efficiency by charging the battery included in the electric vehicle using the external power supply.

In a conventional power supply apparatus, a control circuit unit (also commonly referred to as an engine control unit or ECU) uses a sub-battery, which is for auxiliary equipment use, as a power supply. The control circuit unit controls battery charging and operation of a power control unit (PCU), which includes an inverter for traction use. Consequently, in an abnormal situation in which capacity of the sub-battery is insufficient to start-up the control circuit unit, the conventional power supply apparatus cannot start charging the main battery.

Japanese Patent Application Publication No. 2008-206300 (Patent Literature 1) discloses an art in which a low voltage generator, which passively generates low voltage power through coupling of a connector to a commercial power supply, is included in a power supply apparatus. Through the low voltage power generated by the low voltage generator, a control circuit unit can be started-up even when capacity of a sub-battery is insufficient, and therefore a main battery and the sub-battery can be charged.

### CITATION LIST

### Patent Literature

Patent Literature 1: Japanese Patent Application Publication No. 2008-206300

### SUMMARY OF INVENTION

### Technical Problem

Through addition of the low voltage generator in the conventional art described above, the control circuit unit is started-up by the low voltage power which is generated, commercial electrical power is converted and used to charge the main battery, and subsequently high voltage power of the main battery is converted to low voltage power, which is used to charge the sub-battery.

In other words, charging of the sub-battery is performed after charging of the main battery and conversion of electrical power is performed twice; once to convert for main battery use and once to convert high voltage power charged to the main battery into low voltage power for sub-battery use.

Consequently, in a situation where capacity of the sub-battery is insufficient, if charging of the main battery terminates when the main battery is almost fully-charged (due to uncoupling of the connector), the sub-battery remains insufficiently charged. Therefore, a problem occurs of operation of auxiliary equipment such as wipers not being possible.

Furthermore, electrical power is converted once for main battery use and is subsequently converted again for sub-battery use. Therefore, when the sub-battery is being charged, a problem of increased energy loss occurs due to electrical power conversion being performed twice.

In order to solve the above problems, the present invention provides a power supply apparatus and a charging apparatus for an electric vehicle which, when charging a chargeable main battery and sub-battery of the electric vehicle through an external power supply, is able to charge the sub-battery quickly and efficiently, with little energy loss, even in an abnormal situation in which voltage of the sub-battery is insufficient.

### SOLUTION TO PROBLEM

In order to solve the above problem, the present Description discloses a power supply apparatus for an electric vehicle, the power supply apparatus comprising: a main battery; a sub-battery of lower voltage than the main battery; a first output circuit unit including a first output sub-unit and a second output sub-unit, the first output sub-unit being configured to receive electrical power from a power supply which is external to the electric vehicle and to output first electrical power for charging the main battery, and the second output sub-unit being configured to receive electrical power from the power supply and to output second electrical power for charging the sub-battery; a control circuit unit configured to individually control charging of the main battery by the first electrical power and charging of the sub-battery by the second electrical power; and a second output circuit unit including a third output sub-unit, the third output sub-unit being configured to receive electrical power from the power supply, via a different pathway compared to the first output sub-unit and the second output sub-unit, and to output third electrical power for driving the control circuit unit.

In order to solve the above problem, the present Description also discloses a charging apparatus for an electric vehicle which receives electrical power from a power supply which is external to the electric vehicle and performs charging of a main battery and a sub-battery of lower voltage than the main battery, the charging apparatus comprising: a first output circuit unit including a first output sub-unit and a second output sub-unit, the first output sub-unit being configured to receive electrical power from a power supply which is external to the electric vehicle and to output first electrical power for charging the main battery, and the second output sub-unit being configured to receive electrical power from the power supply and to output second electrical power for charging the sub-battery; a control circuit unit configured to individually control charging of the main battery by the first electrical power and charging of the sub-battery by the second electrical power; and a second output circuit unit including a third output sub-unit, the third output sub-unit being configured to receive electrical power from the power supply, via a different pathway compared to the first output sub-unit and the second output sub-unit, and to output third electrical power for driving the control circuit unit.

### Advantageous Effects of Invention

Through the above configuration, the control circuit unit receives electrical power from the second output circuit unit and therefore can be driven regardless of capacity of the sub-battery. Therefore, when charging the main battery and the sub-battery of the electric vehicle using the external power supply, the sub-battery can be charged quickly and with little energy loss, even in an abnormal situation in which voltage of the sub-battery is insufficient.

### BRIEF DESCRIPTION OF DRAWINGS

FIG. 1 illustrates a configuration during charging of an electric vehicle in a first embodiment.

FIG. 2 illustrates a block diagram of a power supply apparatus relating to the first embodiment.

FIG. 3 illustrates a circuit diagram of the power supply apparatus relating to the first embodiment.

FIG. 4 is a flowchart illustrating operation of a control circuit unit relating to the first embodiment.

FIG. 5 is a flowchart illustrating operation of a control circuit unit relating to a second embodiment.

FIG. 6 illustrates a block diagram of a power supply apparatus relating to a third embodiment.

FIG. 7 is a flowchart illustrating operation of a control circuit unit relating to the third embodiment.

### DESCRIPTION OF EMBODIMENTS

Embodiments of the present invention are explained below with reference to the drawings.

The drawings are rough illustrations, therefore shapes, dimensions and other properties of configurations illustrated in the drawings are not necessarily the same as their actual properties. Also, shapes, materials, numbers and the like explained in the embodiments are merely given as preferable examples thereof, and the present invention is of course not limited thereby. Furthermore, various modifications may be made so long as such modifications do not deviate from scope of the general technical concept of the present invention. Alternatively, configurations in any of the embodiments and modified examples of the present invention may be combined so long as incompatibility does not arise due to combination thereof.

### <Outline>

One aspect of the present invention is a power supply apparatus for an electric vehicle, the power supply apparatus comprising: a main battery; a sub-battery of lower voltage than the main battery; a first output circuit unit including a first output sub-unit and a second output sub-unit, the first output sub-unit being configured to receive electrical power from a power supply which is external to the electric vehicle and to output first electrical power for charging the main battery, and the second output sub-unit being configured to receive electrical power from the power supply and to output second electrical power for charging the sub-battery; a control circuit unit configured to individually control charging of the main battery by the first electrical power and charging of the sub-battery by the second electrical power; and a second output circuit unit including a third output sub-unit, the third output sub-unit being configured to receive electrical power from the power supply, via a different pathway compared to the first output sub-unit and the second output sub-unit, and to output third electrical power for driving the control circuit unit.

The above configuration includes the first output sub-unit and the second output sub-unit in parallel, and the control circuit unit which individually controls charging of the main battery and charging of the sub-battery. Therefore, charging of the sub-battery can be performed concurrently to charging of the main battery, and thus early charging of the sub-battery is possible. Furthermore, the first output sub-unit and the second output sub-unit are in parallel, therefore electrical power received from the power supply, external to the electric vehicle, is directly converted to the second electrical power, and thus energy loss when charging the sub-battery can be reduced.

Alternatively, the sub-battery may be dischargeable to the control circuit unit, and when the sub-battery is fully-charged, the control circuit unit may receive electrical power which is discharged from the sub-battery. Also, the main battery may be for traction use by the electric vehicle, and the sub-battery may be for auxiliary equipment use by the electric vehicle. Furthermore, the first output sub-unit and the second output sub-unit may be isolated from one another by a transformer, which is common to both the first output sub-unit and the second output sub-unit.

Alternatively, the first output circuit unit may comprise: a first transformer circuit provided with a first input coil, a first output coil and a second output coil; a first input circuit configured to receive electrical power from the power supply and input a converted AC voltage into the first input coil; a first output circuit configured to convert AC electrical power from the first output coil into the first electrical power and output the first electrical power; a second output circuit configured to convert AC electrical power from the second output coil into the second electrical power and output the second electrical power; and a first control circuit configured to control start-up of the first input circuit in accordance with a command from the control circuit unit, the first output sub-unit may be configured by the first input circuit, the first transformer circuit and the first output circuit, and the second output sub-unit may be configured by the first input circuit, the first transformer circuit and the second output circuit.

Alternatively, the second output circuit unit may further include a fourth output sub-unit configured to receive electrical power from the power supply, via a different pathway compared to the first output sub-unit and the second output sub-unit, and to output fourth electrical power for driving the first control circuit, the second output circuit unit may comprise: a second transformer circuit provided with a second input coil, a third output coil and a fourth output coil; a second input circuit configured to receive electrical power from the power supply and input a converted AC voltage into the second input coil; a third output circuit configured to convert AC electrical power from the third output coil into the third electrical power and output the third electrical power; and a fourth output circuit configured to convert AC electrical power from the fourth output coil into the fourth electrical power and output the fourth electrical power, the third output sub-unit may be configured by the second input circuit, the second transformer circuit and the third output circuit, and the fourth output sub-unit may be configured by the second input circuit, the second transformer circuit and the fourth output circuit.

Alternatively, the first output circuit and the second output circuit may be electrically isolated from one another, and the third output circuit and the fourth output circuit may be electrically isolated from one another.

Alternatively, the power supply apparatus may further comprise a sub-battery charging circuit unit configured to convert the first electrical power for charging the main battery into electrical power for charging the sub-battery, wherein when voltage of the sub-battery is less than or equal to a threshold value, the control circuit unit may control charging such that the sub-battery is charged using the second electrical power output from the second output sub-unit and is also charged using the electrical power for charging the sub-battery which is output from the sub-battery charging circuit after conversion of the first electrical power output by the first output sub-unit.

Another aspect of the present invention is a charging apparatus for an electric vehicle which receives electrical power from a power supply which is external to the electric vehicle and performs charging of a main battery and a sub-battery of lower voltage than the main battery, the charging apparatus comprising: a first output circuit unit including a first output sub-unit and a second output sub-unit, the first output sub-unit being configured to receive electrical power from a power supply which is external to the electric vehicle and to output first electrical power for charging the main battery, and the second output sub-unit being configured to receive electrical power from the power supply and to output second electrical power for charging the sub-battery; a control circuit unit configured to individually control charging of the main battery by the first electrical power and charging of the sub-battery by the second electrical power; and a second output circuit unit including a third output sub-unit, the third output sub-unit being configured to receive electrical power from the power supply, via a different pathway compared to the first output sub-unit and the second output sub-unit, and to output third electrical power for driving the control circuit unit.

The above configuration includes the first output sub-unit and the second output sub-unit in parallel, and the control circuit unit which individually controls charging of the main battery and charging of the sub-battery. Therefore, charging of the sub-battery can be performed concurrently to charging of the main battery, and thus early charging of the sub-battery is possible. Furthermore, the first output sub-unit and the second output sub-unit are in parallel, therefore electrical power received from the power supply, external to the electric vehicle, is directly converted to the second electrical power, and thus energy loss when charging the sub-battery can be reduced.

### First Embodiment

1. General Structure

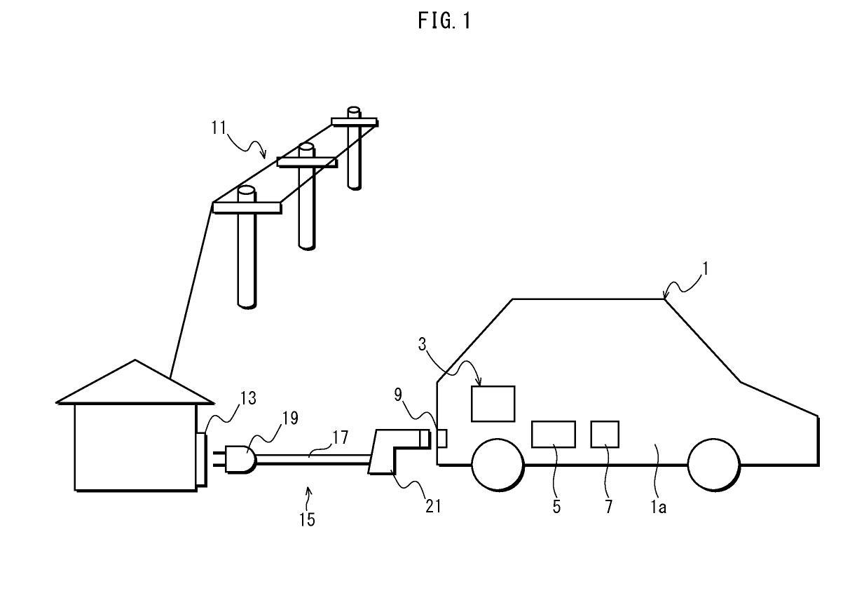

FIG. 1 illustrates a configuration during charging of an electric vehicle in a first embodiment.

In an automobile 1, which is an electric vehicle, a charging apparatus 3, a main battery (high voltage electricity accumulator) 5, and a sub-battery (low voltage electricity accumulator) 7 are positioned in a main body 1a of the automobile 1. A connector 9 is positioned on the main body 1a in order to connect to an external power supply.

When charging the main battery 5 and the sub-battery 7, the automobile 1 may for example be connected via a cable 15 to a commercial power supply 13, which is distributed to households through an electricity grid 11. In the present embodiment, the commercial power supply 13 is used as an example of the external power supply. Alternatively, an EV charging station may be used as the external power supply, or further alternatively both of the above external power supplies may be used as appropriate.

The cable 15 includes a wire 17, a commercial power supply plug 19 and a charging plug 21. The commercial power supply plug 19 is positioned at one end of the wire 17 and connects (couples) to the commercial power supply 13. The charging plug 21 is positioned at the other end of the wire 17 and connects to the connector 9 of the automobile 1.

Herein, the cable 15 is of a type in which the charging plug 21 can be freely attached to and unattached from the connector 9 of the automobile 1. Alternatively, the other end of the wire may for example be connected to the charging apparatus 3 (internally wired type).

When the automobile 1 is connected to the power supply 13 through the cable 15, commercial electrical power is input into the charging apparatus 3 in the automobile 1, via components such as a line filter and a fuse. The charging apparatus 3 is a type of electrical power conversion apparatus using switching for example, which supplies (outputs) electrical power, on which insulation and electrical power (voltage) conversion has been performed, to the main battery 5 and the sub-battery 7, which accumulate the electrical power therein.

Electrical power supplied to the main battery 5 and accumulated therein is mainly consumed as traction energy for traction of the automobile 1. Regenerative energy, which is generated during braking, is also supplied to the main battery 5 and accumulated therein.

Electrical power supplied to the sub-battery 7 and accumulated therein is mainly consumed by so called auxiliary equipment, such as air conditioning, lighting and wipers, and as a power supply for a control system (for example, control circuits and a control circuit unit) configured using a micro computer, dedicated IC (Integrated Circuit) or the like.

The main battery 5 and the sub-battery 7 are both rechargeable batteries. The main battery 5 is for example a lithium battery having an output of 50 kW. The sub-battery 7 is for example a lead battery having an output of 1 kW.

2. Power Supply Apparatus

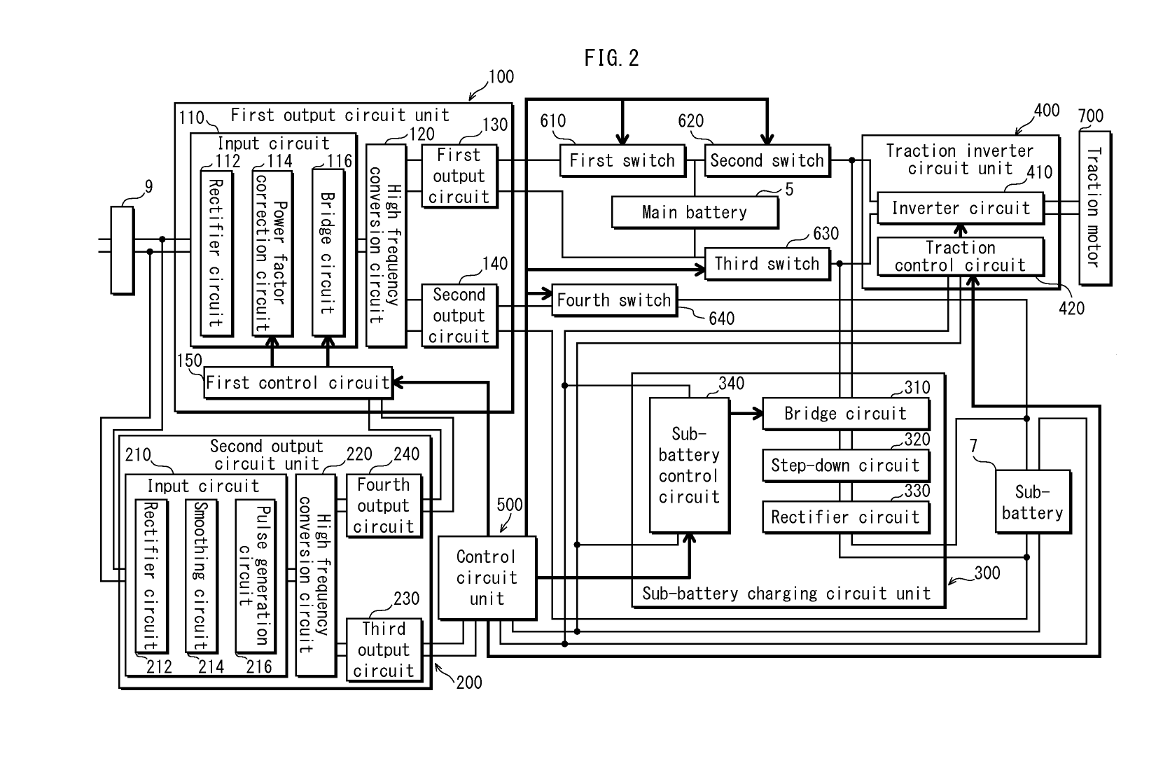

FIG. 2 illustrates a block diagram of a power supply apparatus for an electric vehicle relating to the present embodiment.

In FIG. 2, lines (non-arrowed lines) connecting configuration elements indicate electrical wiring and arrowed lines indicate control signal lines.

The power supply apparatus includes the charging apparatus 3, the main battery 5 and the sub-battery 7. A traction motor illustrated in FIG. 2 is not a configuration element of the power supply apparatus, however the traction motor is illustrated as a load which is driven by the main battery 5.

The charging apparatus 3 includes a first output circuit unit 100, a second output circuit unit 200, a sub-battery charging circuit unit 300, a control circuit unit 500, and switches 610-640 (first switch 610, second switch 620, third switch 630 and fourth switch 640). A traction inverter circuit unit 400 is also included as a configuration element of the charging apparatus 3 in order to charge the main battery 5 through regenerative energy. Of course, the charging apparatus may alternatively have a configuration which does not include the traction inverter circuit unit 400.

(i) First Output Circuit Unit 100

The first output circuit unit 100 includes a first output sub-unit and a second output sub-unit in parallel. The first output sub-unit receives commercial electrical power through the cable 15 and outputs first electrical power for charging the main battery 5. The second output sub-unit receives commercial electrical power through the cable 15 and outputs the second electrical power for charging the sub-battery 7. In other words, the second output sub-unit is not positioned in an output pathway of the first output sub-unit and likewise the first output sub-unit is not positioned in an output pathway of the second output sub-unit. Therefore, output of the second electrical power from the second output sub-unit is not influenced by the first output sub-unit.

The first output circuit unit 100 includes an input circuit 110, a high frequency conversion circuit 120, a first output circuit 130, a second output circuit 140 and a control circuit 150. The input circuit 110, corresponding to the “first input circuit” in the present invention, converts commercial electrical power from alternating current (AC) to, for example, a rectangular wave pulse. The high frequency conversion circuit 120, corresponding to the “first transformer circuit” in the present invention, converts the rectangular wave pulse into two predetermined high frequency electrical powers. The first output circuit 130 and the second output circuit 140 each convert a corresponding one of the high frequency electrical powers into a desired direct current (DC) electrical power and output the DC electrical power therefrom. The control circuit 150 (referred to below as a first control circuit 150 in order to differentiate between other control circuits) controls start-up and pulse waveform of the input circuit 110.

The input circuit 110 includes a rectifier circuit 112, which rectifies the commercial electrical power, a power factor correction circuit 114, which stabilizes the rectified output as DC, and a bridge circuit 116, which converts output from the power factor correction circuit 114 to a rectangular wave pulse.

When the first control circuit 150 receives a command from the control circuit unit 500, the first control circuit 150 commands the input circuit 110 to convert the commercial electrical power to a determined pulse waveform.

Herein, the first output sub-unit is configured by the input circuit 110, the high frequency conversion circuit 120 and the first output circuit 130, and the second output sub-unit is configured by the input circuit 110, the high frequency conversion circuit 120 and the second output circuit 140.

Configurations of each of the above circuits are explained in detail further below. Each of the circuits can be configured using conventional art.

(ii) Second Output Circuit Unit 200

The second output circuit unit 200 includes a third output sub-unit and a fourth output sub-unit in parallel. The third output sub-unit receives electrical power from the commercial power supply through the cable 15, via a different pathway to the first output sub-unit and the second output sub-unit, and outputs third electrical power for supply to the control circuit unit 500. The fourth output sub-unit receives electrical power from the commercial power supply through the cable 15, via a different pathway to the first output sub-unit and the second output sub-unit, and outputs fourth electrical power for driving the first control circuit 150 in the first output circuit unit 100.

In the present embodiment, the fourth output sub-unit is not positioned in an output pathway of the third output sub-unit and likewise the third output sub-unit is not positioned in an output pathway of the fourth output sub-unit. In other words, output of the fourth electrical power from the fourth output sub-unit is not influenced by the third output-sub-unit.

The second output circuit unit 200 includes an input circuit 210, a high frequency conversion circuit 220, a third output circuit 230 and a fourth output circuit 240. The input circuit 210, corresponding to the “second input circuit” in the present invention, converts commercial electrical power from AC to, for example, a rectangular wave pulse. The high frequency conversion circuit 220, corresponding to the “second transformer circuit” in the present invention, converts the rectangular wave pulse into two predetermined high frequency electrical powers. The third output circuit 230 and the fourth output circuit 240 each convert a corresponding one of the high frequency electrical powers into a desired DC electrical power and output the DC electrical power therefrom.

The input circuit 210 includes a rectifier circuit 212, which rectifies the commercial electrical power, a smoothing circuit 214, which smoothes rectified electrical current, and a pulse generation circuit 216.

The third output sub-unit is configured by the input circuit 210, the high frequency conversion circuit 220 and the third output circuit 230. The fourth output sub-unit is configured by the input circuit 210, the high frequency conversion circuit 220 and the fourth output circuit 240.

Configuration of each of the above circuits is described in detail further below.

(iii) Sub-Battery Charging Circuit Unit 300

The sub-battery charging circuit unit 300 is an electrical power conversion circuit which charges the sub-battery 7 using the main battery 5 as an input. The sub-battery charging circuit unit 300 converts the first electrical power of the main battery 5, which is high electrical power, into the second electrical power for the sub-battery, which is low electrical power.

The sub-battery charging circuit unit 300 includes a bridge circuit 310, a step-down circuit 320, a rectifier circuit 330 and a control circuit 340. The bridge circuit 310 converts the first electrical power from the main battery 5 to AC. The step-down circuit 320 reduces voltage of the first electrical power. The rectifier circuit 330 rectifies the AC electrical power, which has been stepped-down, into DC electrical power (power supply). The control circuit 340 controls the bridge circuit 310 and is referred to below as a sub-battery control circuit 340 in order to differentiate between other control circuits. Configuration of each of the above circuits is described in detail further below.

(iv) Traction Inverter Circuit Unit 400

The traction inverter circuit unit 400 drives a traction motor 700 using output from the main battery 5. Specifically, the traction inverter circuit unit 400 uses the main battery 5 as an input and generates a polyphase AC output, for example a three phase AC output, for driving the traction motor 700. Traction of the automobile 1 can be achieved through driving of the traction motor 700.

The traction inverter circuit unit 400 includes an inverter circuit 410, which converts output from the main battery 5 into polyphase (herein, three phase) AC electrical power, and a control circuit 420 which controls the inverter circuit 410. The control circuit 420 is referred to below as a traction control circuit 420 in order to differentiate between other control circuits.

(v) Control Circuit Unit 500

The control circuit unit 500 controls elements such as the first output circuit unit 100, the sub-battery charging circuit unit 300 and the traction inverter circuit unit 400. The control circuit unit 500 is for example configured by an IC which is programmed in advance.

The control circuit unit 500 is configured to receive electrical power mainly from the sub-battery 7 for start-up and driving thereof. During charging, the control circuit unit 500 can also receive electrical power from the third output circuit 230 in the second output circuit unit 200.

(vi) Switches 610-640

The first switch 610 is for switching between connection and isolation of the main battery 5 relative to the first output circuit 130 in the first output circuit unit 100. During supply of electrical power to the main battery 5, the first switch 610 is set to on by a control signal from the control circuit unit 500.

In a normal situation the main battery 5 is used for traction. In other words, normally discharge from the main battery 5 is performed with respect to the traction inverter circuit unit 400. Therefore, in the above situation the first switch 610 isolates the main battery 5 from the first output circuit unit 100 in order that discharge with respect to the first output circuit unit 100 is prevented.

The second switch 620 and the third switch 630 are for switching between connection and isolation of the main battery 5 relative to the traction inverter circuit unit 400. The second switch 620 and the third switch 630 are set to on by a control signal from the control circuit unit 500 during driving of the traction motor 700 using output from the main battery 5, during charging of the sub-battery 7 using output from the main battery 5, or during charging of the main battery 5 using regenerative energy from the traction motor 700.

During charging of the main battery 5, the second switch 620 and the third switch 630 isolate the main battery 5 from the traction inverter circuit unit 400 in order that discharge from the main battery 5 with respect to the traction inverter circuit unit 400 is prevented.

The fourth switch 640 is for switching between connection and isolation of the sub-battery 7 relative to the second output circuit 140 in the first output circuit unit 100. During supply of electrical power to the sub-battery 7, the fourth switch 640 is set to on by a control signal from the control circuit unit 500. In a normal situation the sub-battery 7 is sufficiently charged for use, and therefore the fourth switch 640 isolates the sub-battery 7 from output from the second output circuit 140.

3. Circuit Configuration

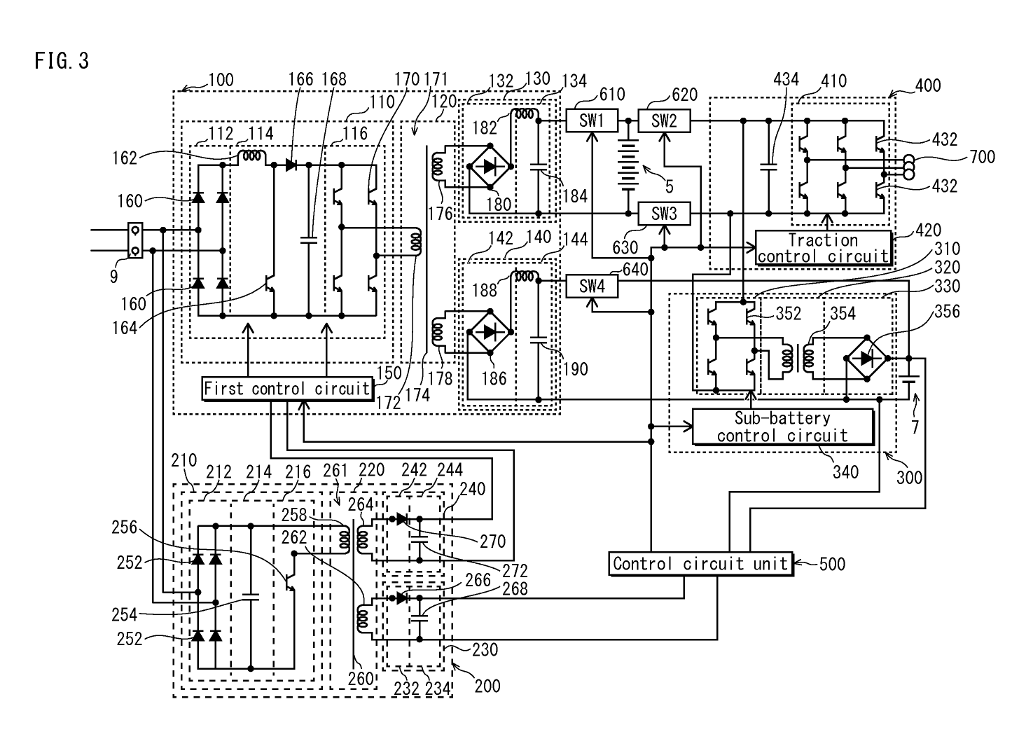

FIG. 3 illustrates a circuit diagram of the power supply apparatus relating to the present embodiment.

(i) First Output Circuit Unit 100

The following explains the input circuit 110 in the first output circuit unit 100.

The rectifier circuit 112 is for example a so called diode bridge, which uses four diodes 160.

The power factor correction circuit 114 for example includes a choke coil 162, a switching element (herein, a transistor) 164, a diode 166 and a capacitor 168. The power factor correction circuit 114 is a type of step-up converter circuit, which may also be referred to as a DC-DC converter.

The bridge circuit 116 includes four switching elements (herein, transistors) 170 in a bridged connection.

In the present embodiment, the high frequency conversion circuit 120 is configured by a transformer 171. The transformer 171 includes an input coil (corresponding to the “first input coil” in the present invention) 172, a core 174, a first output coil 176 and a second output coil 178. An output (AC voltage), which is converted to a rectangular wave pulse in the input circuit 110, is applied to the input coil 172. Magnetic energy generated in the core 174 can be received by the first output coil 176 and the second output coil 178 as pulsed electrical power.

The first control circuit 150 is for example configured by a programmed IC. The first control circuit 150 sends an on/off signal (square wave) with respect to the switching element 164 in the power factor correction circuit 114 and the switching elements 170 in the bridge circuit 116. As illustrated in FIGS. 2 and 3, the first control circuit 150 receives electrical power from the fourth output circuit 240 in the second output circuit unit 200.

The first output circuit 130 includes a rectifier circuit 132, which rectifies a pulse electrical current output from the first output coil 176, and a smoothing circuit 134, which smoothes the rectified electrical current. The first output circuit 130 outputs DC electrical power (first electrical power) of a predetermined voltage. The rectifier circuit 132 is configured by a diode bridge 180, and the smoothing circuit 134 is configured by a choke coil 182 and a capacitor 184.

The second output circuit 140 includes a rectifier circuit 142, which rectifies a pulse electrical current output from the second output coil 178, and a smoothing circuit 144, which smoothes the rectified electrical current. The second output circuit 140 outputs DC electrical power (second electrical power) of a predetermined voltage. The rectifier circuit 142 is configured by a diode bridge 186 and the smoothing circuit 144 is configured by a choke coil 188 and a capacitor 190.

Consequently, the first output sub-unit is configured by the input circuit 110, the high frequency conversion circuit 120 and the first output circuit 130, and the second output sub-unit is configured by the input circuit 110, the high frequency conversion circuit 120 and the second output circuit 140.

The first electrical power, which is DC electrical power output by the first output circuit 130, is determined by a time ratio of pulses output by the input circuit 110 and by a turn ratio of the first output coil 176 to the input coil 172 in the high frequency conversion circuit (transformer) 120. The second electrical power, which is DC electrical power output by the second output circuit 140, is determined by the time ratio of pulses output by the input circuit 110 and by a turn ratio of the second output coil 178 to the input coil 172 in the high frequency conversion circuit (transformer) 120. The time ratio of pulses and each of the turn ratios are set in order to achieve desired DC voltages for the first electrical power and the second electrical power.

(ii) Second Output Circuit Unit 200

The input circuit 210 in the second output circuit unit 200 is configured by a rectifier circuit 212, a smoothing circuit 214 and a pulse generation circuit 216. The rectifier circuit 212 is configured by a so called diode bridge, which for example uses four diodes 252, the smoothing circuit 214 is configured by a smoothing capacitor 254, and the pulse generation circuit 216 is configured by a switching element (herein, a transistor) 256.

The switching element 256 detects connection of the commercial power supply to the vehicle and commences on/off switching, through which the input circuit 210 can output a rectangular wave pulse.

In the present embodiment, the high frequency conversion circuit 220 is configured by a transformer 261. The transformer 261 includes an input coil (corresponding to the “second input coil” in the present invention) 258, a core 260, a third output coil 262 and a fourth output coil 264. Output from the input circuit 210, which had been converted into a rectangular wave pulse (AC voltage), is applied to the input coil 258. Magnetic energy generated by the core 260 can be received by the third output coil 262 and the fourth output coil 264 as pulse electrical power.

The third output circuit 230 includes a rectifier circuit 232, which rectifies a pulse electrical current output from the third output coil 262, and a smoothing circuit 234, which smoothes the rectified electrical current. The third output circuit 230 outputs DC electrical power (third electrical power) of a predetermined voltage. Due to low electrical power in the third output circuit 230, the rectifier circuit 232 is configured by a diode 266 in the present embodiment. The smoothing circuit 234 is configured by a capacitor 268.

The fourth output circuit 240 includes a rectifier circuit 242, which rectifies a pulse electrical current output from the fourth output coil 264, and a smoothing circuit 244, which smoothes the rectified electrical current. The fourth output circuit 240 outputs DC electrical power (fourth electrical power) of a predetermined voltage. Due to low electrical power in the fourth output circuit 240, the rectifier circuit 242 is configured by a diode 270 in the present embodiment. The smoothing circuit 244 is configured using a capacitor 272.

Consequently, the third output sub-unit is configured by the input circuit 210, the high frequency conversion circuit 220 and the third output circuit 230, and the fourth output sub-unit is configured by the input circuit 210, the high frequency conversion circuit 220 and the fourth output circuit 240.

The third electrical power, which is DC electrical power output by the third output circuit 230, is determined by a time ratio of pulses output by the input circuit 210 and by a turn ratio of the third output coil 262 to the input coil 258 in the high frequency conversion circuit (transformer) 220. The fourth electrical power, which is DC electrical power output by the fourth output circuit 240, is determined by the time ratio of pulses output by the input circuit 210 and by a turn ratio of the fourth output coil 264 to the input coil 258 in the high frequency conversion circuit (transformer) 220. The time ratio of pulses and each of the turn ratios are set in order to achieve a desired DC voltage.

(iii) Sub-Battery Charging Circuit Unit 300

The bridge circuit 310 in the sub-battery charging circuit unit 300 is configured by four switching elements 352 in bridge connection. The step-down circuit 320 is configured by a step-down transformer 354. The rectifier circuit 330 is configured by a diode bridge 356.

(iv) Traction Inverter Circuit Unit 400

An inverter circuit 410 in the traction inverter circuit unit 400 includes a plurality of series connection branches which are connected in parallel to one another. Each of the series connection branches includes two switching elements 432 connected in series. The series connection branches are equal in number to a number of phases of the polyphase electrical current, which in the present embodiment is three. Also, on an input side of the inverter circuit 410, a capacitor 434 for smoothing is connected in parallel to each of the series connection branches.

(v) Switches 610-640

The first switch 610, the second switch 620, the third switch 630 and the fourth switch 640 are indicated in FIG. 3 by reference signs SW1, SW2, SW3 and SW4 respectively.

Each of the switches 610-640 is switched between on and off by a control signal from the control circuit unit 500, and may for example be configured by a relay. In a configuration in which each of the switches 610-640 is configured by a relay, the signal is passing or blocking of electrical current in order to switch an electromagnet of the relay between on and off.

4. Implementation Examples

In terms of the main battery 5, a required voltage may for example be 288 V. In order to implement the above, the main battery 5 may be a lithium ion battery in which 72 cells are connected in series, wherein each cell has a voltage of 4 V. In terms of the sub-battery 7, a required voltage may for example be 12 V. In order to implement the above, the sub-battery 7 may be a lead-acid battery in which 6 cells are connected in series, wherein each cell has a voltage of 2 V.

The required voltages recited above for the main battery 5 and the sub-battery 7 are merely examples thereof, and the required voltages may be appropriately modified based on factors such as battery capacity loss or increased efficiency of other circuits. Alternatively, the number of cells and the connection method thereof may also be appropriately modified. Furthermore, a number of rows can be designed in accordance with battery capacity specification and is unrelated to voltage.

The high frequency conversion circuit 120 in the first output circuit unit 100 is configured by a magnetic core, which is formed from a ferrite material, and a plurality of conducting coils, which are wound around the magnetic core, such that the high frequency conversion circuit 120 can transmit or isolate a high frequency pulse electrical current in the order of tens to hundreds of kHz.

In the transformer 171 which configures the high frequency conversion circuit 120, when both a primary side and a secondary side have a full-bridge configuration, typically a turn ratio of the input coil 172 to the first output coil 176 is between 2:1 and 1:1.

A ratio of voltage applied at the primary side and voltage received at the secondary side is roughly equivalent to the turn ratio multiplied by the pulse time ratio, which is controlled by the first control circuit 150.

The above explanation also applies with regards to the primary side and a tertiary side (second output coil 178).

The turn ratio of the first output coil 176 to the second output coil 178 is set in accordance with a ratio of battery voltages corresponding to the first output coil 176 and the second output coil 178. When setting the turn ratio as explained above, by adopting a value of approximately 24:1 for the turn ratio, two different voltage outputs can be acquired which are of a desired ratio to one another and are based on the pulse time ratio, which is common to both the voltage outputs.

5. Operation of Control Circuit Unit 500

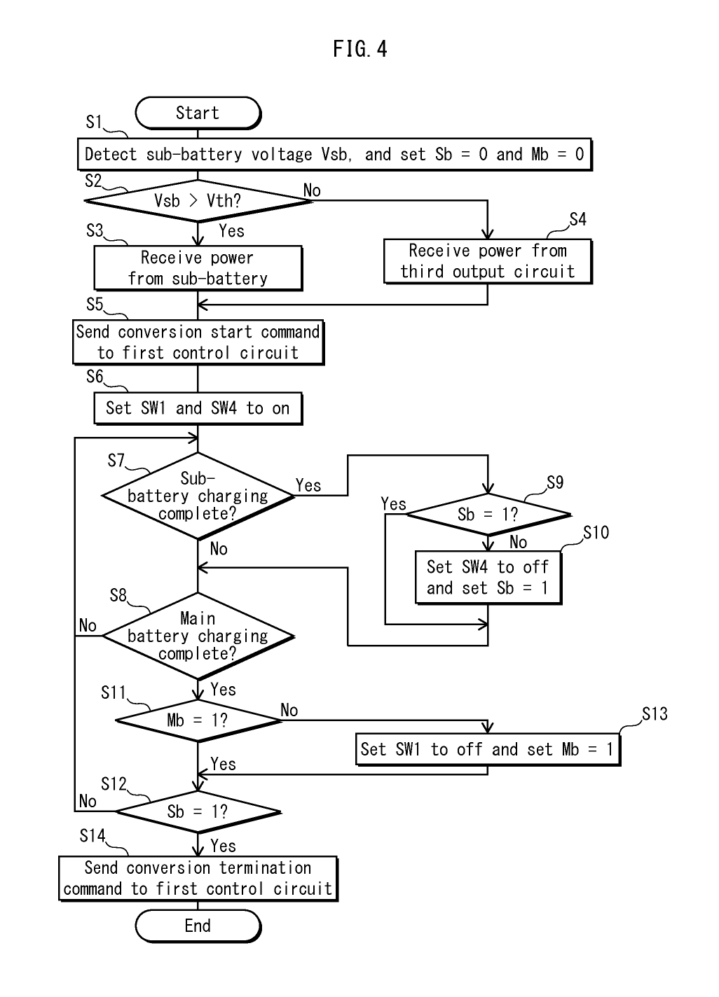

FIG. 4 is a flowchart illustrating operation of the control circuit unit 500.

The control circuit unit 500 starts-up when the third electrical power is output from the third output circuit 230, and starts a program. The above corresponds to “Start” in FIG. 4.

When operation starts, the control circuit unit 500 detects a voltage Vsb of the sub-battery 7 and sets constants Mb and Sb, which indicate charge states of the main battery 5 and the sub-battery 7 respectively, to “0” (Step S1).

The control circuit unit 500 judges whether the voltage Vsb which is detected is greater than a reference voltage (threshold value) Vth, which is a voltage of the sub-battery 7 used as a reference for determining a scheme for electrical power supply to the control circuit unit 500 (Step S2). The threshold value Vth is set as a value which is within a range of 60% to 90% of a voltage of the sub-battery 7 when fully-charged. Herein, the threshold value Vth is set as 75% of the voltage when fully-charged.

When the voltage Vsb is judged to be greater than the threshold value Vth (Step S2: Yes), the control circuit unit 500 receives electrical power from the sub-battery 7 (Step S3). When the voltage Vsb is judged to be less than or equal to the threshold value Vth (Step S2: No), the control circuit unit 500 receives electrical power from the third output circuit 230 (Step S4).

Through the above, sufficient electrical power is secured for driving of the control circuit unit 500. For example, in a situation in which capacity of the sub-battery 7 is low, the control circuit unit 500 can be started-up and driven by the third electrical power, which is obtained through conversion of the commercial electrical power.

Next, in order to charge the main battery 5 and the sub-battery 7, the control circuit unit 500 sends a conversion start command to the first control circuit 150 so that the first output circuit unit 100 is driven (Step S5). The control circuit unit 500 also sets the first switch 610 to on in order that the first output circuit unit 100 is connected to the main battery 5, and sets the fourth switch 640 to on in order that the first output circuit unit 100 is connected to the sub-battery 7.

Next, the control circuit unit 500 judges whether charging of the sub-battery 7 is complete (Step S7). The control circuit unit 500 performs the judgment by temporarily setting the fourth switch 640 to off, measuring voltage of the sub-battery 7, and judging based on the voltage which is measured. In other words, the voltage which is measured is judged whether to be at least equal to a voltage at which charging is considered to be complete (for example, a voltage which is 95% of voltage of the sub-battery 7 when fully-charged).

When charging of the sub-battery 7 is not complete (Step S7: No), the control circuit unit 500 judges whether charging of the main battery 5 is complete (Step S8) while the fourth switch is set to on (while the sub-battery 7 is being charged). The control circuit unit 500 performs the judgment in the same way as for the sub-battery 7, by temporarily setting the first switch 610 to off, measuring voltage of the main battery 5, and judging based on the voltage which is measured. In other words, the voltage which is measured is judged whether to be at least equal to a voltage at which charging is considered to be complete (for example, a voltage which is 95% of voltage of the main battery 5 when fully-charged).

In Step S7, when charging of the sub-battery 7 is complete (Step S7: Yes), the control circuit unit 500 judges whether the constant Sb is set to “1”, which indicates that charging of the sub-battery 7 is complete (Step S9). When the constant Sb is set to “1” (Step S9: Yes), operation proceeds to Step S8. When the constant Sb is not set to “1” (Step S9: No), the control circuit unit 500 sets the fourth switch 640 to off and sets the constant Sb to “1” in order that charging of the sub-battery 7 is terminated (Step S10), and operation proceeds to Step S8. Through the above, overcharging of the sub-battery 7 when already fully-charged is prevented and the sub-battery 7 is maintained in a charged state.

In Step S8, the control circuit unit 500 judges whether charging of the main battery 5 is complete. When charging of the main battery 5 is not complete (Step S8: No), operation is repeated from Step S7. On the other hand, when charging of the main battery 5 is complete (Step S8: Yes), the control circuit unit 500 judges whether the constant Mb is set to “1”, which indicates that charging is complete (Step S11).

When the constant Mb is set to “1” (Step S11: Yes), operation proceeds to Step S12, which is explained further below. When the constant Mb is not set to “1” (Step S11: No), the control circuit unit 500 sets the first switch 610 to off and sets the constant Mb to “1” in order to terminate charging of the main battery 5 (Step S13), and operation proceeds to Step S12. Through the above, overcharging is prevented when the main battery 5 is already fully-charged and the main battery 5 is maintained in a charged state.

In Step S12, the control circuit unit 500 judges whether the constant Sb is set to “1”. When operation proceeds to Step S12, charging of the main battery 5 has already been judged to be complete in Step S8, and when the constant Sb is judged to be set to “1” in Step S12 (Step S12: Yes), charging of the sub-battery 7 is also complete. In other words, in the above situation charging is complete for both the main battery 5 and the sub-battery 7, and therefore the control circuit unit 500 sends a conversion termination command to the first control circuit 150 (Step S14).

In Step S12, when the constant Sb is not set to “1” (Step S12: No), charging of the main battery 5 is complete but charging of the sub-battery 7 is not complete, therefore operation is repeated from Step S7 in order that charging is continued only for the sub-battery 7.

As explained above, when charging the automobile 1 including the main battery 5 and the sub-battery 7, which are both chargeable batteries, the sub-battery 7 can be quickly recharged through the second electrical power, which is received efficiently from the external power supply through the second output circuit 140 in the first output circuit unit 100, while also securing sufficient electrical power for operation of the control circuit unit 500, which is a control circuit that controls charging using the external power supply. Therefore the automobile 1 implements a configuration wherein, even in an abnormal state in which voltage of the sub-battery 7 is insufficient, the automobile 1 is able to quickly recover to a normal state.

6. Conclusion

(i) In the first output circuit unit 100 the commercial electrical power is converted to the first electrical power using the high frequency conversion circuit 120 (transformer 171). In other words, the first output circuit unit 100 includes the input coil 172, the first output coil 176 which is set with regards to the first electrical power for the main battery 5, the rectifier circuit 132 and the smoothing circuit 134.

The second electrical power for the sub-battery 7 can be easily obtained by including, in addition to the input coil 172 (inclusive of the core) which is provided for the main battery 5, the second output circuit 140 which is for example configured by the second output coil 178 set with regards to the sub-battery 7, the rectifier circuit 142 and the smoothing circuit 144.

As explained above, a system for charging the sub-battery 7 can be obtained by using part of a configuration of an electrical power convertor which is used for the main battery 5. Through such a configuration, the second electrical power for charging the sub-battery 7 can be obtained at lower cost and on a much smaller scale than in a configuration in which a new power supply circuit (first output circuit unit 100) for the sub-battery 7 is added.

Furthermore, by using control signals and pulse voltage in the input circuit 110, which are set with regards to the first output circuit 130, and adjusting output from the second output circuit 140 through the turn ratio of the first output coil 176 to the second output coil 178, the same control signals and pulse voltage can be used in the input circuit 110 for the second output circuit 140. Through the above, there is no fundamental requirement for provision of an additional control circuit or control IC.

(ii) In the second output circuit unit 200, in addition to the fourth output circuit 240 which supplies electrical power to the first control circuit 150, a third output circuit 230 is included in parallel to the fourth output circuit 240. The third output circuit 230 ensures that when plugged-in sufficient electrical power can be obtained for start-up and driving of the control circuit unit 500, through the cable 15 from the commercial power supply 13, via a different pathway compared to the first output circuit unit 100.

The above can be implemented at lower cost and on a relatively small scale by for example providing the rectifier circuit 232, the smoothing circuit 234 and an additional coil (third output coil 262) in the transformer 261, which is a configuration element (fourth output sub-unit) of the second output circuit unit 200.

Power supply (electrical power) for the control circuit unit 500 can be obtained from the third output circuit 230 as the third electrical power. Thus, the control circuit unit 500 can be started-up and consequently operations can be performed such as judging charge state of the main battery 5 and the sub-battery 7, and generating commands for the control circuits 150, 340 and 420 and the switches 610-640. When the sub-battery 7 is in a normal charge state, the control circuit unit 500 can also obtain power supply from the sub-battery 7.

(iii) By using the transformer 171 to configure the high frequency conversion circuit 120, the first output circuit 130 and the second output circuit 140 can be electrically isolated from one another.

Likewise, by using the transformer 261 to configure the high frequency conversion circuit 220, the third output circuit 230 and the fourth output circuit 240 can be electrically isolated from one another. Through the above, electrical power can be simultaneously supplied to the control circuit unit 500 and the first control circuit 150, which differ in terms of standard electric potential.

### Second Embodiment

In the first embodiment, the control circuit unit 500 starts charging of the main battery 5 and the sub-battery 7 regardless of charge state (for example, voltage) of the main battery 5 and the sub-battery 7.

In a second embodiment, the control circuit unit 500 performs charging of the main battery 5 and the sub-battery 7 in accordance with respective charge states thereof. A power supply apparatus relating to the second embodiment has the same configuration as the power supply apparatus relating to the first embodiment, however a control circuit unit in the power supply apparatus relating to the second embodiment performs control differently compared to in the first embodiment.

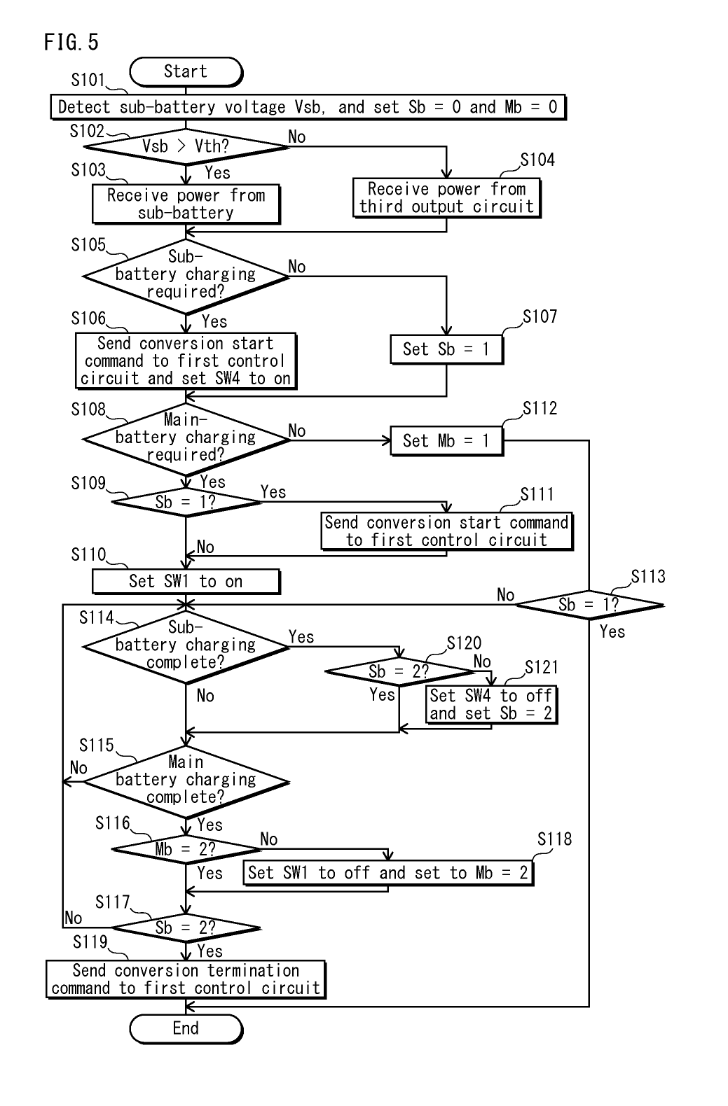

FIG. 5 is a flowchart illustrating operation of a control circuit unit 500 relating to the second embodiment.

Steps S101-S104 illustrated in FIG. 5 are the same as Steps S1-S4 in the first embodiment (refer to FIG. 4), therefore operation is explained from Step S105.

In Step S105 the control circuit unit 500 judges whether charging of the sub-battery 7 is required. The control circuit unit 500 may for example perform the above judgment by setting the fourth switch 640 to off, measuring voltage of the sub-battery 7, and judging whether the voltage is higher or lower than a threshold value. The threshold value is used as a judgment reference as to whether or not charging is required.

When charging of the sub-battery 7 is required (Step S105: Yes), the control circuit unit 500 sends a conversion start command to the first control circuit 150 and sets the fourth switch 640 to on (Step S106). Through the above, charging of the sub-battery 7 starts.

When charging of the sub-battery 7 is not required (Step S105: No), the control circuit unit 500 sets the constant Sb to “1” (Step S107) and operation proceeds to Step S108. Herein, when charging of the sub-battery 7 is not required, charging of the sub-battery 7 is considered to be complete and the constant Sb is set to “1”.

In Step S108, the control circuit unit 500 judges whether charging of the main battery 5 is required. The control circuit unit 500 may for example perform the above judgment in the same way as for the sub-battery 7, by setting the first switch 610 to off, measuring voltage of the main battery 5, and judging whether the voltage is higher or lower than a threshold value. The threshold value is used as a judgment reference as to whether or not charging is required.

When charging of the main battery 5 is required (Step S108: Yes), the control circuit unit 500 judges whether the constant Sb is set to “1” (Step S109). When the constant Sb is not set to “1” (Step S109: No), the control circuit unit 500 sets the first switch 610 to on (Step S110), and when the constant Sb is set to “1” (Step S109: Yes), the control circuit unit 500 sends a conversion start command to the first control circuit 150 (Step S111), and operation proceeds to Step 5110. Through the above, charging of the main battery 5 starts.

When charging of the main battery 5 is not required (Step S108: No), the control circuit unit 500 sets the constant Mb to “1” (Step S112) and operation proceeds to Step S113. Herein, when charging of the main battery 5 is not required, charging of the main battery 5 is considered to be complete.

In Step S113, the control circuit unit 500 judges whether the constant Sb is set to “1”. When the constant Sb is set to “1” (Step S113: Yes), charging of the sub-battery 7 is not required and operation proceeds to “End”. When the constant Sb is not set to “1” (Step 5113: No), charging of the sub-battery 7 is required and operation proceeds to Step S114.

In Step S114, the control circuit unit 500 judges whether charging of the sub-battery 7 is complete. The control circuit unit 500 performs the above judgment in the same way as explained for judging completion of charging of the sub-battery 7 in the first embodiment.

When charging of the sub-battery 7 is not complete (Step S114: No), the control circuit unit 500 judges whether charging of the main battery 5 is complete (Step S115). When charging of the main battery 5 is not complete (Step S115: No), operation is repeated from Step S114 in order that charging is continued. When charging of the main battery 5 is complete (Step S115: Yes), operation proceeds to Step S116.

In Step S116, the control circuit unit 500 judges whether the constant Mb, which indicates information relating to charge state of the main battery 5, is set to “2”. Herein, the constant Mb being set to “2” indicates that charging of the main battery 5 is complete and the first switch is set to off. In other words, the above indicates that discharge is prevented and the main battery 5 is maintained in a charged state.

When the constant Mb is set to “2”, the control circuit unit 500 judges whether the constant Sb, which indicates information relating to a charge state of the sub-battery 7, is set to “2” (Step S117).

In Step S117, when the constant Sb is not set to “2” (Step S117: No), charging of the sub-battery 7 is not complete, thus operation is repeated from Step S114 in order that charging of the sub-battery 7 is continued. When the constant Sb is set to “2” (Step S117: Yes), charging is complete for both the main battery 5 and the sub-battery 7, and thus the control circuit unit sends a conversion termination command to the first control circuit 150 (Step S119), and operation proceeds to “End”.

In Step S116, when the constant Mb is not set to “2” (Step S116: No), charging of the main battery 5 is continuing, thus the control circuit unit 500 sets the first switch 610 to off and sets the constant Mb to “2” (Step S118), and operation proceeds to Step S117.

On the other hand, when charging of the sub-battery 7 is complete in Step S114, the control circuit unit 500 judges whether the constant Sb is set to “2” (Step S120). When the constant Sb is set to “2” (Step S120: Yes), the fourth switch 640 is already set to off, therefore operation proceeds to Step S115. When the constant Sb is not set to “2” (Step S120: No), the control circuit unit 500 sets the fourth switch 640 to off and sets the constant Sb to “2” (Step S121), and operation proceeds to Step S115.

As explained above, the control circuit unit 500 only sends a conversion start signal to the first control circuit 150 after judging charge states of the main battery 5 and the sub-battery 7. Therefore, the first output circuit unit 100 is not operated when charging of the main battery 5 and the sub-battery 7 is not required, and thus unnecessary consumption of electrical power can be prevented.

### Third Embodiment

In the first embodiment and the second embodiment, the sub-battery 7 is charged using the second electrical power output from the second output circuit 140 in the first output circuit unit 100. However, alternatively the sub-battery 7 may be charged using the first electrical power output from the first output circuit 130 or by discharge from the main battery 5.

The following explains a third embodiment in which, when the sub-battery 7 is in an abnormally low charge state and rapid charging is required, the sub-battery 7 is charged using the first electrical power output from the first output circuit 130.

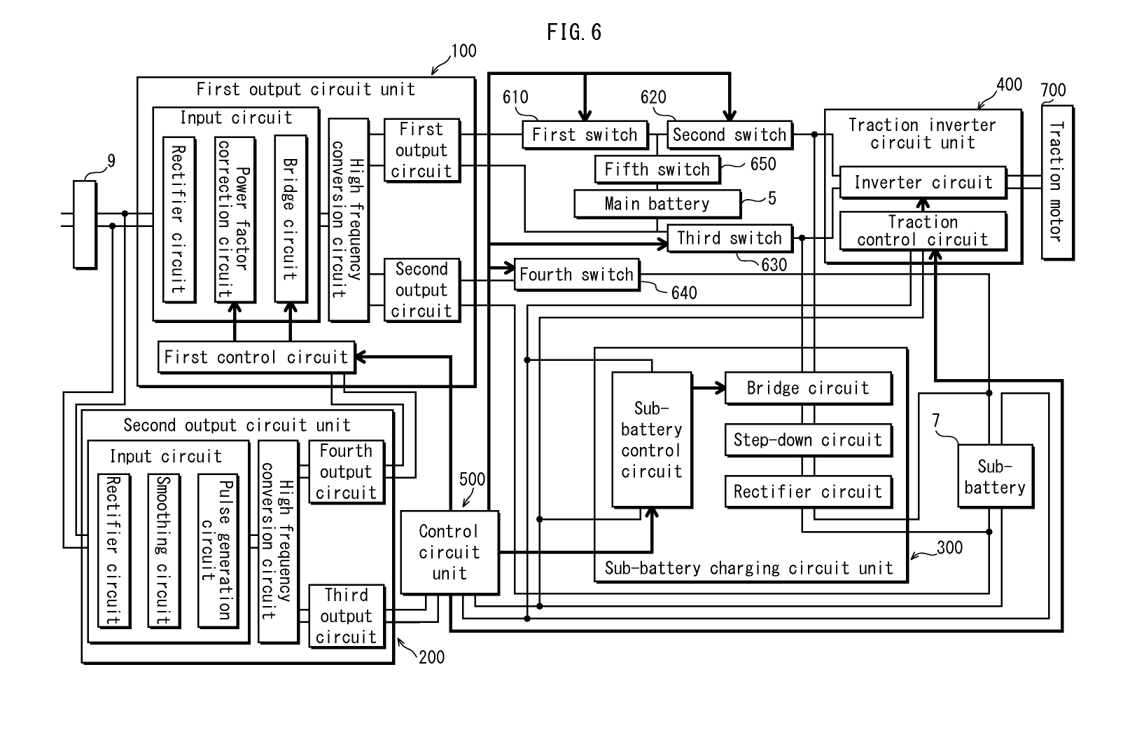

FIG. 6 illustrates a block diagram of a power supply apparatus relating to the third embodiment.

As illustrated in FIG. 6, in addition to the configuration in the first embodiment, the power supply apparatus further includes a fifth switch 650, which is connected in series relative to the main battery 5. In the above configuration, the sub-battery 7 can be charged through supply of the first electrical power via the sub-battery charging circuit 300, without supplying the first electrical power to the main battery 5, by for example setting the first switch 610, the second switch 620 and the third switch 630 to on and setting the fifth switch 650 to off.

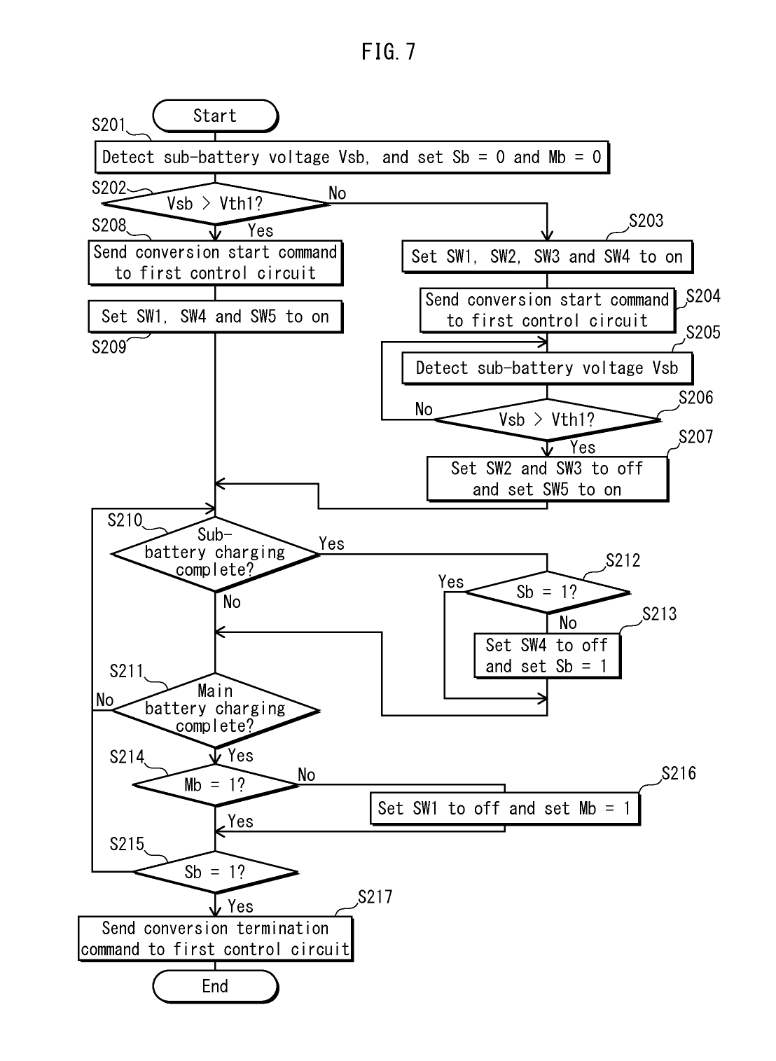

FIG. 7 is a flowchart illustrating operation of a control circuit unit 500 relating to the third embodiment.

The control circuit unit 500 relating to the third embodiment is started-up when the third electrical power is output from the third output circuit 230, and a program illustrated in FIG. 7 starts. In the third embodiment, the control circuit unit 500 is configured to receive electrical power from the second output circuit unit 200 during charging (when plugged-in), regardless of charge state of the sub-battery 7.

When operation starts, the control circuit unit 500 detects a voltage Vsb of the sub-battery 7 and sets constants Mb and Sb, which indicate charge states of the main battery 5 and the sub-battery 7 respectively, to “0” (Step S201).

The control circuit unit 500 judges whether the voltage Vsb is greater than a reference voltage (threshold value) Vth1, which is used as a reference as to whether rapid charging of the sub-battery 7 is required (Step S202).

When the voltage Vsb is less than or equal to the threshold value Vth1 (Step S202: No), rapid charging of the sub-battery 7 is required. The threshold value Vth is for example set as a value which is within a range of 60% to 90% of a voltage of the sub-battery 7 when fully-charged. Herein, the threshold value Vth is set as 75% of the voltage when fully-charged.

When there is a negative judgment in Step S202 (Step S202: No), the control circuit unit 500 sets the first switch 610, the second switch 620, the third switch 630 and the fourth switch 640 to on (Step S203), and sends a conversion start command to the first control circuit 150 (Step S204). Through the above, the sub-battery 7 is charged in a rapid charging mode, using both the second electrical power, which is provided for charging the sub-battery 7, and also the first electrical power, which in a normal situation is provided for charging the main battery 5.

Next, in order to assess charge state of the sub-battery 7, the control circuit unit 500 detects voltage Vsb of the sub-battery 7 (Step S205) and judges whether the voltage Vsb exceeds the threshold value Vth1 (Step S206).

When the voltage Vsb is less than or equal to the threshold value Vth1 (Step S206: No), continuation of rapid charging is required, thus operation is repeated from Step S205 in order that rapid charging is continued. When the voltage Vsb is greater than the threshold value Vth1 (Step S206: Yes), the sub-battery 7 has returned to a charge state for normal use and consequently rapid charging is not required. Therefore, the control circuit unit 500 sets the second switch 620 and the third switch 630 to off, and sets the fifth switch 650 to on (Step S207), in order to terminate rapid charging. Next, operation proceeds to Step S210.

When there is an affirmative judgment in Step S202 (Step S202: Yes), rapid charging of the sub-battery 7 is not required, therefore charging of the main battery 5 and the sub-battery 7 is performed in a normal charging mode.

When there is an affirmative judgment in Step S202 (Step S202: Yes), the control circuit unit 500 sends a conversion start command to the first control circuit 150 (Step S208), and sets the first switch 610, the fourth switch 640 and the fifth switch 650 to on (Step S209). Through the above, the main battery 5 and the sub-battery 7 are charged in the normal charging mode.

Control performed in steps from Step S210 onwards is roughly the same as control performed in steps from Step S7 onwards in the first embodiment (refer to FIG. 4), therefore explanation is omitted. Steps S210-S217 relating to the present embodiment correspond to Step S7-S14 relating to the first embodiment.

### Modified Examples

The above explains configuration of the present invention based on the first, second and third embodiments, however the present invention is not limited to the embodiments explained above. Various modified examples such as explained below are also possible.

1. Electric Vehicle

In the embodiments, the electric vehicle is explained using an electric automobile as an example, however the electric vehicle is not limited to being an electric automobile (or a specialized version thereof, such as a forklift truck), and may alternatively be a hybrid electric vehicle provided with a combustion engine, or a motorcycle.

2. Batteries

In the above embodiments, the main battery and the sub-battery are explained as having voltages of 288 V and 12 V respectively. However, so long as the voltages of the main battery and the sub-battery differ from one another, with the voltage of the main battery being greater than the voltage of the sub-battery, the voltages of the main battery and the sub-battery are not limited to the above values.

For example, the main battery may have a voltage in a range of 100 V to 650 V, and preferably in a range of 200 V to 450 V. The sub-battery may have a voltage in a range of 5 V to 50 V, and preferably in a range of 7 V to 17 V.

3. External Power Supply

In the embodiments the external power supply is a commercial power supply for household use (100 V), but alternatively the external power supply may be a 200 V power supply. Further alternatively, the external power supply may be a power supply such as a solar cell or a fuel cell.

4. Switches

In the embodiments, output to a battery which is not to be charged is prevented by using switches (first switch 610, fourth switch 640) to cut-off charging current. However, charging current may be limited through a different configuration, for example alternatively the smoothing circuit 134, 144 or the rectifier circuit 132, 142 in the first output circuit 130 or the second output circuit 140 may be configured by an active switch, such as a transistor, and charging current may be cut-off through a control signal thereto.

5. Control Circuit Unit

In the third embodiment, the control circuit unit differentiates between control modes in accordance with voltage of the sub-battery. Alternatively, further sub-division of control modes can be applied in order to reduce charging time or to restrict temperature increase due to heat loss. Applications such as described above should also be considered to be types of differentiation by the control circuit unit.

6. Sub-Battery Charging Circuit Unit

Conventionally, a sub-battery charging circuit unit is used for charging a sub-battery (7) or for operating auxiliary equipment or control circuits, using a main battery (5) as a source for electrical power. However, when plugged-in to an external power supply, the above electrical power can be obtained from the second output circuit 140 in the first output circuit unit 100, and thus the sub-battery charging circuit unit may be set in a suspended state or a state equivalent thereto.

In the above configuration, by setting the sub-battery charging circuit unit in the suspended state, an efficient system can be implemented in which little electrical power loss occurs during charging operation and unnecessary electrical power consumption is restricted.

Herein, a state equivalent to the suspended state, may for example refer to a state in which a time ratio or pulse frequency of a pulse electrical current generated by the bridge circuit (310) is lower than normal. The above state may for example be implemented by a command from the control circuit unit 500 to the sub-battery control circuit 340 in the sub-battery charging circuit unit 300.

7. First Output Circuit Unit

In the embodiments, the input circuit and the high frequency conversion circuit are circuits which are common to both the first output sub-unit and the second output sub-unit. In other words, the first output sub-unit and the second output sub-unit both include the input circuit and the high frequency conversion circuit. In an alternative configuration, the first output sub-unit and the second output sub-unit may each be configured as an independent circuit. In other words, the first output sub-unit and the second output sub-unit may not include circuits which are common to both the first output sub-unit and the second output sub-unit.

Even in a configuration in which the first output sub-unit and the second output sub-unit are independent of one another, the sub-battery can be charged efficiently and the advantageous effects of the present invention can be achieved.

8. Battery Charge State

In the embodiments a charge state of a battery is judged based on voltage of the battery, but alternatively voltage change of the battery may for example be detected and the battery may be judged to be fully-charged when the voltage change is in a predetermined range.

In another example, voltage of the battery may be measured prior to charging, a charging time may be calculated based on the voltage, and the battery may be judged to be fully-charged once the charging time has passed.

### INDUSTRIAL APPLICABILITY

The present invention is applicable for use in a vehicle, such as an electric vehicle or a plug-in hybrid electric vehicle, having an electric motor as a source of drive and being capable of receiving electrical power from an external power supply, for which there is a demand for a charging apparatus and a charging system of small scale, high efficiency and high reliability.

### REFERENCE SIGNS LIST

1 automobile
3 charging apparatus
5 main battery
7 sub-battery
13 commercial power supply
100 first output circuit unit
150 first control circuit
200 second output circuit unit
300 sub-battery charging circuit unit
400 traction inverter circuit unit
500 control circuit unit
610 first switch
620 second switch
630 third switch
640 fourth switch

1-9. (canceled)

10. A power supply apparatus for an electric vehicle, the power supply apparatus comprising:
a main battery;
a sub-battery of lower voltage than the main battery;
a first output circuit unit including a first output sub-unit and a second output sub-unit, the first output sub-unit being configured to receive electrical power from a power supply which is external to the electric vehicle and to output first electrical power for charging the main battery, and the second output sub-unit being configured to receive electrical power from the power supply and to output second electrical power for charging the sub-battery;
a control circuit unit configured to individually control charging of the main battery by the first electrical power and charging of the sub-battery by the second electrical power; and
a second output circuit unit including a third output sub-unit, the third output sub-unit being configured to receive electrical power from the power supply, via a different pathway compared to the first output sub-unit and the second output sub-unit, and to output third electrical power for driving the control circuit unit.

11. The power supply apparatus of claim 10, wherein
the sub-battery is dischargeable to the control circuit unit, and
when the sub-battery is fully-charged, the control circuit unit receives electrical power which is discharged from the sub-battery.

12. The power supply apparatus of claim 10, wherein
the main battery is for traction use by the electric vehicle, and
the sub-battery is for auxiliary equipment use by the electric vehicle.

13. The power supply apparatus of claim 11, wherein
the main battery is for traction use by the electric vehicle, and
the sub-battery is for auxiliary equipment use by the electric vehicle.

14. The power supply apparatus of claim 10, wherein
the first output sub-unit and the second output sub-unit are isolated from one another by a transformer, which is common to both the first output sub-unit and the second output sub-unit.

15. The power supply apparatus of claim 13, wherein
the first output sub-unit and the second output sub-unit are isolated from one another by a transformer, which is common to both the first output sub-unit and the second output sub-unit.

16. The power supply apparatus of claim 10, wherein
the first output circuit unit comprises:
a first transformer circuit provided with a first input coil, a first output coil and a second output coil;
a first input circuit configured to receive electrical power from the power supply and input a converted AC voltage into the first input coil;
a first output circuit configured to convert AC electrical power from the first output coil into the first electrical power and output the first electrical power;
a second output circuit configured to convert AC electrical power from the second output coil into the second electrical power and output the second electrical power; and
a first control circuit configured to control start-up of the first input circuit in accordance with a command from the control circuit unit,
the first output sub-unit is configured by the first input circuit, the first transformer circuit and the first output circuit, and
the second output sub-unit is configured by the first input circuit, the first transformer circuit and the second output circuit.

17. The power supply apparatus of claim 15, wherein
the first output circuit unit comprises:
a first transformer circuit provided with a first input coil, a first output coil and a second output coil;
a first input circuit configured to receive electrical power from the power supply and input a converted AC voltage into the first input coil;
a first output circuit configured to convert AC electrical power from the first output coil into the first electrical power and output the first electrical power;
a second output circuit configured to convert AC electrical power from the second output coil into the second electrical power and output the second electrical power; and
a first control circuit configured to control start-up of the first input circuit in accordance with a command from the control circuit unit,
the first output sub-unit is configured by the first input circuit, the first transformer circuit and the first output circuit, and
the second output sub-unit is configured by the first input circuit, the first transformer circuit and the second output circuit.

18. The power supply apparatus of claim 16, wherein
the second output circuit unit further includes a fourth output sub-unit configured to receive electrical power from the power supply, via a different pathway compared to the first output sub-unit and the second output sub-unit, and to output fourth electrical power for driving the first control circuit,
the second output circuit unit comprises:
a second transformer circuit provided with a second input coil, a third output coil and a fourth output coil;
a second input circuit configured to receive electrical power from the power supply and input a converted AC voltage into the second input coil;
a third output circuit configured to convert AC electrical power from the third output coil into the third electrical power and output the third electrical power; and
a fourth output circuit configured to convert AC electrical power from the fourth output coil into the fourth electrical power and output the fourth electrical power,
the third output sub-unit is configured by the second input circuit, the second transformer circuit and the third output circuit, and
the fourth output sub-unit is configured by the second input circuit, the second transformer circuit and the fourth output circuit.

19. The power supply apparatus of claim 17, wherein
the second output circuit unit further includes a fourth output sub-unit configured to receive electrical power from the power supply, via a different pathway compared to the first output sub-unit and the second output sub-unit, and to output fourth electrical power for driving the first control circuit,
the second output circuit unit comprises:
a second transformer circuit provided with a second input coil, a third output coil and a fourth output coil;
a second input circuit configured to receive electrical power from the power supply and input a converted AC voltage into the second input coil;
a third output circuit configured to convert AC electrical power from the third output coil into the third electrical power and output the third electrical power; and
a fourth output circuit configured to convert AC electrical power from the fourth output coil into the fourth electrical power and output the fourth electrical power,
the third output sub-unit is configured by the second input circuit, the second transformer circuit and the third output circuit, and
the fourth output sub-unit is configured by the second input circuit, the second transformer circuit and the fourth output circuit.

20. The power supply apparatus of claim 18, wherein
the first output circuit and the second output circuit are electrically isolated from one another, and
the third output circuit and the fourth output circuit are electrically isolated from one another.

21. The power supply apparatus of claim 19, wherein
the first output circuit and the second output circuit are electrically isolated from one another, and
the third output circuit and the fourth output circuit are electrically isolated from one another.

22. The power supply apparatus of claim 10, further comprising
a sub-battery charging circuit unit configured to convert the first electrical power for charging the main battery into electrical power for charging the sub-battery, wherein
when voltage of the sub-battery is less than or equal to a threshold value, the control circuit unit controls charging such that the sub-battery is charged using the second electrical power output from the second output sub-unit and is also charged using the electrical power for charging the sub-battery which is output from the sub-battery charging circuit after conversion of the first electrical power output by the first output sub-unit.

23. The power supply apparatus of claim 21, further comprising
a sub-battery charging circuit unit configured to convert the first electrical power for charging the main battery into electrical power for charging the sub-battery, wherein
when voltage of the sub-battery is less than or equal to a threshold value, the control circuit unit controls charging such that the sub-battery is charged using the second electrical power output from the second output sub-unit and is also charged using the electrical power for charging the sub-battery which is output from the sub-battery charging circuit after conversion of the first electrical power output by the first output sub-unit.

24. A charging apparatus for an electric vehicle, the charging apparatus receiving electrical power from a power supply which is external to the electric vehicle and performing charging of a main battery and a sub-battery of lower voltage than the main battery, the charging apparatus comprising:
a first output circuit unit including a first output sub-unit and a second output sub-unit, the first output sub-unit being configured to receive electrical power from a power supply which is external to the electric vehicle and to output first electrical power for charging the main battery, and the second output sub-unit being configured to receive electrical power from the power supply and to output second electrical power for charging the sub-battery;
a control circuit unit configured to individually control charging of the main battery by the first electrical power and charging of the sub-battery by the second electrical power; and
a second output circuit unit including a third output sub-unit, the third output sub-unit being configured to receive electrical power from the power supply, via a different pathway compared to the first output sub-unit and the second output sub-unit, and to output third electrical power for driving the control circuit unit.
